(19) United States
(12) Patent Application Publication
(10) Pub. No.: US 2007/0076886 A1
(43) Pub. Date: Apr. 5, 2007

(54) Network device, network system and method for updating a key

(76) Inventors: Satoru Hori, Yokohama (JP); Takayoshi Fujioka, Yokohama (JP); Shigetoshi Sameshima, Machida (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/527,476

(22) Filed: Sep. 27, 2006

(30) Foreign Application Priority Data
Oct. 4, 2005 (JP) 2005-291414

(51) Int. Cl. H04L 9/00

(52) U.S. Cl. 380/277

(57) ABSTRACT

When conducting encryption key update, each of the network device successively causes transition among an initial state in which only data encrypted using an old encryption key used before the update can be transmitted and received, a state in which both data encrypted using the old encryption key and data encrypted using a new encryption key used after the update can be transmitted and received, but operation concerning transmission and reception of data encrypted using the new encryption key is not confirmed, a state in which both data encrypted using the old encryption key and data encrypted using the new encryption key can be transmitted and received, and operation concerning transmission and reception of data encrypted using the new encryption key is already also confirmed, and a final state in which only data encrypted using the new encryption key can be transmitted and received. The encryption key is thus updated.

### INCORPORATION BY REFERENCE

The present application claims priority from Japanese application JP 2005-291414 filed on Oct. 4, 2005, the content of which is hereby incorporated by reference into this application.

### BACKGROUND OF THE INVENTION

The present invention relates to a network device, a network system, and a method for updating a key. In particular, the present invention relates to a network device for connecting a facility device, a home electric appliance, a device such as a sensor, and various devices installed in a building or a town, a network system including the network device, and a method for updating a key in the network device.

In recent years, it begins to be attempted to provide a new service by mounting a network function on devices such as not only PCs (Personal Computers) but also devices in factories, AV (Audio Visual) devices in home such as television and video devices, and white goods such as refrigerators, air conditioners and illuminations. It is now under study to utilize a radio communication device which does not need wire infrastructures or base stations, in order to connect various devices to a network as described above and make communication between devices possible.

In a method of connecting devices to each other in a radio form and conducting communication, however, it becomes extremely easy to monitor the communication as compared with the case where the devices are connected in a wire form and it is difficult to ensure the ciphering property of communication contents. Furthermore, there is a problem that when controlling a device via the network an impersonating third party might conduct operation by illegal communication.

For ensuring the ciphering property of communication contents described above in radio communication, it is necessary to encrypt communication data and periodically update a key used for encryption.

As a conventional technique for periodically update a key used to encrypt communication data, a technique described in, for example, JP-A-9-319673 is known. This conventional technique relates to an encryption key updating method in an encrypted communication network in a system including an encryption key server which orders update of an encryption key in order to raise the communication safety and a plurality of clients which receive an order from the encryption key server. In this conventional technique, the encryption key server repeats transmission of encryption key update data to each client and reception of an ACK (ACKnowledgement) signal which shows that the encryption key update data has been received, from each client, successively. When receiving encryption key update data and returning an ACK signal, each client stores the new encryption key. And in this conventional technique, each client continues use of an old encryption key, receives an update permission from the encryption key server which receives a predetermined ACK signal from the clients by broadcast communication, and changes over an encryption key used by each client from an old encryption key to a new encryption key all at once.

As another conventional technique, a technique described in, for example, U.S. Patent Publication No. 2004/228492 is known. This conventional technique relates to a technique for updating an encryption key in encrypted communication in a mobile ad hoc network. This conventional technique includes a step of causing a node A to generate a private key and a public key according to a first encryption method, a step of causing the node A to transmit the generated public key to a node B, receive a cryptogram transmitted from the node B, and decrypt the cryptogram by using a private key of itself, and a step of causing the node A to generate a private key and a public key according to a second encryption method by using the decrypted cryptogram, encrypt the generated public key according to the second encryption method by using the public key according to the first encryption method, and transmit the encrypted public key to the node B.

### SUMMARY OF THE INVENTION

In the conventional technique described in JP-A-9-319673, it is possible to update an encryption key correctly, when the key update server, which delivers a new encryption key and issues a key changeover instruction, conducts communication directly with a client which is given the new encryption key and receives the key changeover instruction. In the case where a network device relays message data to another network device, however, key changeover in the relaying device conducted earlier than in the device of relay destination makes communication with the device of relay destination impossible. This results in a problem that it becomes impossible to update the encryption key.

According to the conventional technique described in U.S. Patent Publication No. 2004/228492, the key update can be conducted correctly even in the case where the communication route in the network varies dynamically. Since every node needs to retain public keys of network devices having a possibility of being used for communication by the node, the quantity of memory in use becomes large. Furthermore, since the arithmetic unit is demanded to have high processing capability when generating a key used for encryption, there is a problem that a larger size, a cost increase and increased power consumption of a network device are caused.

As described above, the methods according to the conventional techniques relate to the key update method in the ordinary network system or the key update method in the case where the communication route dynamically changes. In a network in which a network device having a relay function is present, however, the key update method in the ordinary network system has a problem that there is a possibility that key update in all network devices will not be conducted correctly when a key in a relaying network device is updated earlier than a key in a terminal network device.

If, in the case where the communication route is fixed, a network device which transmits an encryption key update instruction transmits an instruction to conduct encryption key changeover in order beginning with the remotest network device, encryption key changeover in all network devices can be conducted correctly. In the case of a network in which the communication route changes dynamically and it cannot be known beforehand, however, such a technique cannot be applied.

The key update method using the private key and the public key in the network having the dynamically changing communication route has a problem that it is difficult to reduce the size of network devices because the processing capability of the arithmetic unit and the memory quantity in use increase. In addition, when newly adding a network device, it is necessary to cause existing network devices to retain a public key of the network device to be newly added, resulting in a problem of an increased labor required when expanding the network.

The method of inquiring of an authentication station about a public key of another network device poses a problem that a large sized processor is needed to implement practical update time and a cost for installing the authentication station is needed.

As heretofore described, the methods according to the conventional techniques have problems such as that the key update is not conducted correctly, that size reduction is hampered by the necessity of a large-sized processor and a large number of variable storage memories, and that the cost at the time of expansion is high.

An object of the present invention is to provide a network device having a relay function capable of updating an encryption key by using a simple method and ensuring the ciphering property of communication even if the network device is low in processing capability and small in storage memory capacity, a network system including the network device, and a key update method in the network device.

The present invention is achieved by providing a management unit which retains and manages an encryption key used for communication in the network, a first transmission unit which transmits a new encryption key used after update encrypted by using an old encryption key used before the update to other network devices and orders encryption key update, at time of encryption key update, a first reception unit which receives a reception response for the new encryption key encrypted by using the old encryption key from other network devices, a second transmission unit which transmits a response request encrypted by using the new encryption key to other network devices when the reception response for the new encryption key is received, and a second reception unit which receives a response encrypted by using the new encryption key from other network devices, and by updating an encryption key of network devices to be updated.

Furthermore, the present invention is achieved by providing a management unit which retains and manages an encryption key used for communication in the network, a first reception unit which receives a new encryption key used after update encrypted by using an old encryption key used before the update from a network device which orders encryption key update, a first transmission unit which transmits a reception response encrypted by using the old encryption key to the network device which has ordered the encryption key update, when the new encryption key is received, a second reception unit which receives a response request encrypted by using the new encryption key from the network device which has ordered the encryption key update, and a second transmission unit which transmits a response encrypted using the new encryption key to the network device which has ordered the encryption key update, in response to the received response request, in order to update an encryption key of the own network device.

Furthermore, the present invention is achieved by providing the steps of delivering a new encryption key used after update encrypted by using an old encryption key used before the update to other network devices, delivering a response request encrypted by using the new encryption key after confirming reception of the old encryption key in other network devices, and confirming a response from other network devices encrypted by using the new encryption key.

According to the present invention, it becomes possible to update an encryption key of network devices to be updated, in a network system including small-sized network devices each having a relay function, without knowing a communication route beforehand and without contradiction. As a result, it is possible to ensure the ciphering property of communication in a network formed of small-sized, low price network devices with low power consumption each having a relay function.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a configuration example of a network device according to an embodiment of the present invention;

FIG. 2 is a block diagram showing a configuration example of a network system according to an embodiment of the present invention including a plurality of network devices;

FIG. 3 is a diagram showing state transitions in a network device at time of key update;

FIG. 4 is a diagram showing a key retained in a memory by a network device and a key used at time of transmission, in an initial state;

FIG. 5 is a diagram showing a key retained in a memory by a network device and a key used at time of transmission, in a state “a”;

FIG. 6 is a diagram showing a key retained in a memory by a network device and a key used at time of transmission, in a state “b”;

FIG. 7 is a diagram showing a key retained in a memory by a network device and a key used at time of transmission, in a final state;

FIG. 8 is a flow chart showing processing operation in a network device which transmits a key update instruction in an initial state;

FIG. 9 is a flow chart showing processing operation in a network device which receives a key update instruction in an initial state;

FIG. 10 is a flow chart showing processing operation in a network device which transmits a key update instruction in a state “a”;

FIG. 11 is a flow chart showing processing operation in a network device which receives a key update instruction in a state “a”;

FIG. 12 is a flow chart showing processing operation in a network device which transmits a key update instruction in a state “b”;

FIG. 13 is a flow chart showing processing operation in a network device which receives a key update instruction in a state “b”;

FIG. 14 is a diagram showing an example of a network which is a part of a network system shown in FIG. 2 in the case where a communication route between network devices having a relay function varies;

FIG. 15 is a diagram showing communication routes at the time when an obstacle is not present in the example of the network shown in FIG. 14;

FIG. 16 is a diagram showing a communication route at the time when an obstacle 1405 is present as in the example of the network shown in FIG. 14;

FIG. 17 is a diagram showing communication routes from a network device which transmits a key update instruction to each network device which receives the key update instruction in each of the case where an obstacle is present in a route and the case where an obstacle is not present;

FIG. 18 is a diagram showing processing conducted when a new network device is added to a network system including a plurality of network devices which are conducting encrypted communication;

FIG. 19 is a diagram showing processing conducted when removing one network device from a network system including a plurality of network devices which are conducting encrypted communication; and

FIG. 20 is a diagram showing processing conducted when a network device which transmits an encrypted key update instruction has stopped its function, in a network system including a plurality of network devices which are conducting encrypted communication.

### DESCRIPTION OF THE EMBODIMENTS

Hereafter, embodiments of a network device, a network system including the network device, and a method for updating a key in the network device according to the present invention will be described in detail with reference to the drawings.

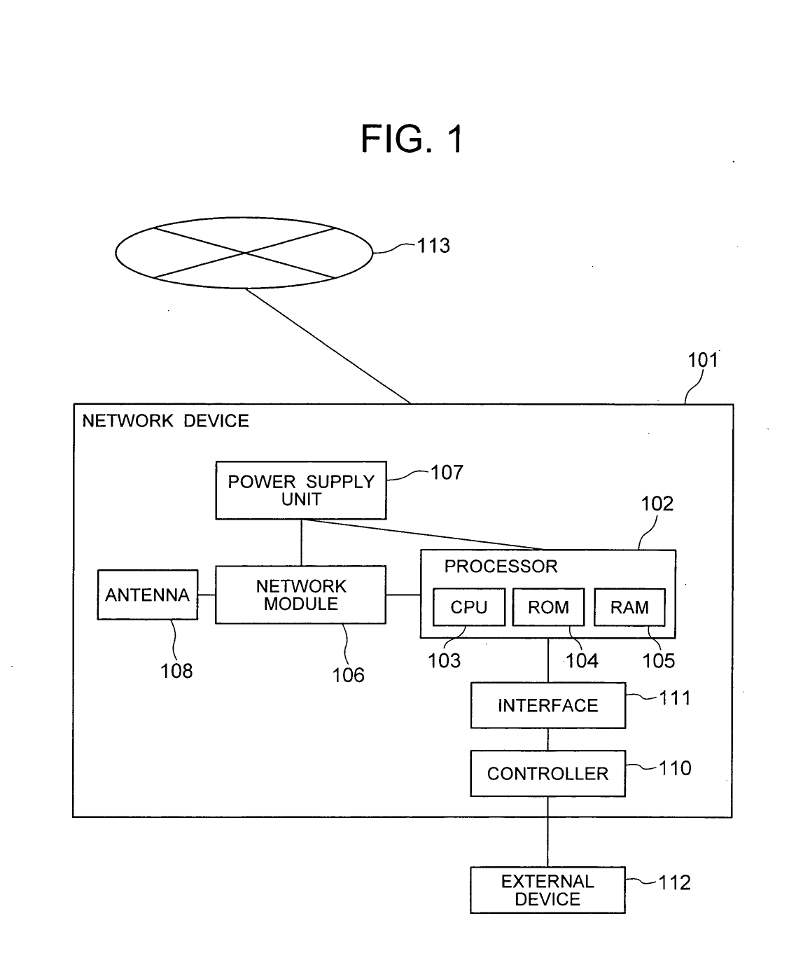

FIG. 1 is a block diagram showing a configuration example of a network device according to an embodiment of the present invention. In FIG. 1, reference numeral 101 denotes a network device, 102 denotes a processor, 103 denotes a CPU, 104 denotes a ROM, 105 denotes a RAM, 106 denotes a network module, 107 denotes a power supply unit, 108 denotes an antenna, 110 denotes a controller, 111 denotes an interface, 112 denotes an external device, and 113 denotes a network.

The network device 101 shown in FIG. 1 has a function of conducting communication and relay between network devices. The network device 101 controls the external device 112, which is a facility device, a home electric appliance, a device such as a sensor, or one of various devices installed in a building or a town. Furthermore, the network device 101 can take in sensor information and state information of the external device 112 and transmit them to another network device.

The network device 101 includes the processor 102, the network module 106, the power supply unit 107, the antenna 108, the controller 110 and the interface 111. The network device 101 is connected to the network 113. The processor 102 includes the CPU 103, the ROM 104 and the RAM 105. The processor 102 is connected to the power supply unit 107, the network module 106 and the interface 111.

The CPU 103 is a central processing unit, which can execute a program recorded in the ROM 104 or the RAM 105 or previously transferred to the RAM 105 from the ROM 104 or a storage. The ROM (Read Only Memory) 104 is a storage unit which records data or a program. The RAM (Random Access Memory) 105 is a storage unit which temporarily records a program or data.

The network module 106 conducts radio communication processing between it and a radio network. The network module 106 is connected to the power supply unit 107, the processor 102 and the antenna 108. The power supply unit 107 supplies power to components. The power supply unit 107 is connected to the network module 106 and the processor 102. The antenna 108 emits an electric signal output from the network module 106, as a radio wave, or receives a radio wave and inputs it to the network module 106 as an electric signal. The antenna 108 is connected to the network module 106.

The controller 110 is a device which operates the external device 112 according to an instruction given by the processor, or transmits a state of the external device 112 to the processor. The controller 110 is connected to the interface 111 and the external device 112. The interface 111 converts an electric signal in the processor 102 and an electric signal in the controller 110 to each other. The interface 111 is connected to the controller 110 and the processor 102.

The network 113 is a device used to exchange messages and packets between devices by using radio waves, light, sounds, or electric signals. The network 113 includes routers and cables. The network 113 is connected to the network device 101.

The network device 101 shown in FIG. 1 constitutes a radio network by using the antenna 108. When constituting an infrared ray radio network by using a combination of infrared ray receiving and infrared ray output, the network device 101 can constitute the network in the same way by using an infrared ray emitting device and an infrared ray receiving device instead of the antenna 108. When constituting a network using electric signals, the network device 101 can constitute the network in the same way by using a connector for the network instead of the antenna 108.

The external device 112 may be white goods such as an air-conditioner or a refrigerator, a facility device such as a door or a switch, or an AV device such as a TV set. In the example shown in FIG. 1, the network device 101 is separated from the external device 112. Alternatively, the network device 101 may be physically incorporated in the external device 112. Furthermore, if the interface 111 uses radio communication such as an infrared ray remote control interface, the controller 110 may be installed in a physically remote position.

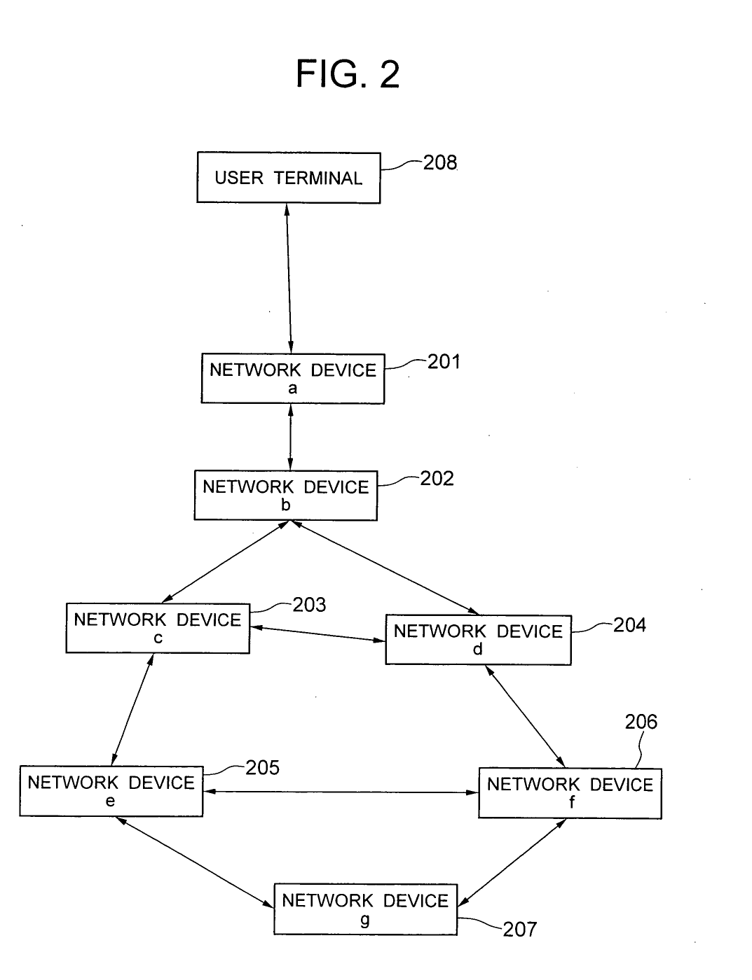

FIG. 2 is a block diagram showing a configuration example of a network system according to an embodiment of the present invention including a plurality of network devices. In FIG. 2, reference numerals 201 to 207 denote network devices “a” to “g” and reference numeral 208 denotes a user terminal.

The network system shown in FIG. 2 includes a network in the case where a plurality of network devices 101 each having a relay function are included. A communication route between network devices is a communication route via which the network devices can communicate with each other by using a communication function performed by the antenna 108 and the network module 106. And this communication route depends upon the distance between network devices or an obstacle between the network devices. Communication routes shown in FIG. 2 represent an example thereof.

In the configuration example of the network system shown in FIG. 2, a network device “a” 201 is connected to a network device “b” 202 and a user terminal 208. The network device “b” 202 is connected to the network device “a” 201, a network device “c” 203 and a network device “d” 204. The network device “c” 203 is connected to the network device “b” 202, a network device “e” 205 and the network device “d” 204. The network device “d” 204 is connected to the network device “b” 202, the network device “c” 203 and a network device “f” 206. The network device “e” 205 is connected to the network device “c” 203, a network device “g” 207 and the network device “f” 206. The network device “f” 206 is connected to the network device “d” 204, the network device “g” 207, and the network device “e” 205. In addition, the network device “g” 207 is connected to the network device “e” 205 and the network device “f” 206.

The user terminal 208 is used to monitor and control a network device by a user, such as a personal computer, a PDA (Personal Digital Assistant) or a mobile phone. The user terminal 208 is connected to the network device “a” 201.

By the way, the example in FIG. 2 shows a configuration having a user terminal 208 which operates the network device “a” 201. Alternatively, a configuration in which the user terminal 208 is not present and network devices cooperate autonomously may be used.

As for, for example, the communication route to control the network device “g” 207 by using the user terminal 208 in the example shown in FIG. 2, it is possible to assume a plurality of communication routes such as “the user terminal 208→the network device “a” 201→the network device “b” 202→the network device “c” 203→the network device “e” 205→the network device “g” 207″ and “the user terminal 208→the network device “a” 201→the network device “b” 202→the network device “d” 204→the network device “f” 206→the network device “g” 207.” Since this communication route is determined according to the communication environment and states of the network devices, it cannot be known beforehand.

When securing the ciphering property of communication between network devices on the above-described network, it is necessary to encrypt communication data. Therefore, each network device stores information of an encryption key and information concerning the use of the key in the RAM 105 or the rewritable ROM 104 in the network device and manages the information. The key information is updated at regular intervals or at irregular intervals. At the time of key update in the embodiment of the present invention, each network device retains information of the key used before and after the update and information representing which key should be used to encrypt transmission data, causes a device state transition while confirming states of all network devices, and conducts key update.

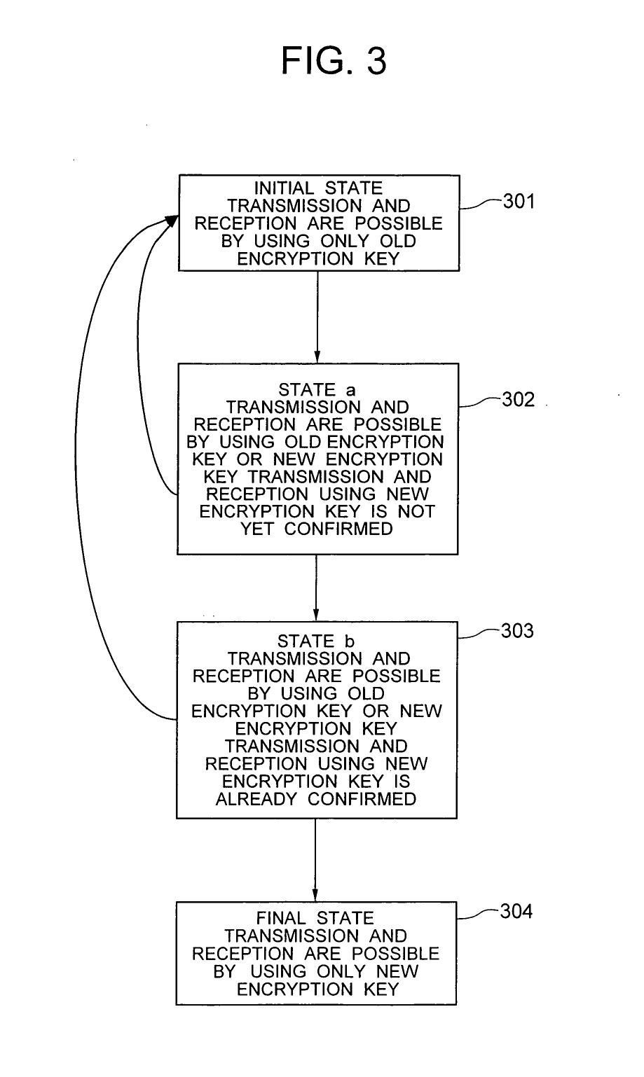

FIG. 3 is a diagram showing state transitions in a network device at the time of key update. This will now be described.

When conducting key update processing, the network device causes a transition among four states: an initial state 301, a state “a” 302, a state “b” 303 and a final state 304 shown in FIG. 3, one after another. The initial state 301 is a state in which only data encrypted by using an old encryption key used before the update can be transmitted and received. The state “a” 302 is a state in which both data encrypted by using the old encryption key and data encrypted by using a new encryption key used after the update can be transmitted and received, but operation concerning transmission and reception of data encrypted by using the new encryption key is not yet confirmed. The state “b” 303 is a state in which both data encrypted by using the old encryption key and data encrypted by using the new encryption key can be transmitted and received, and operation concerning transmission and reception of data encrypted by using the new encryption key is also already confirmed. The final state 304 is a state after the key update is completed. The final state 304 is a state in which only data encrypted by using the new encryption key can be transmitted and received.

Internal states of the network device in the above-described states will now be described.

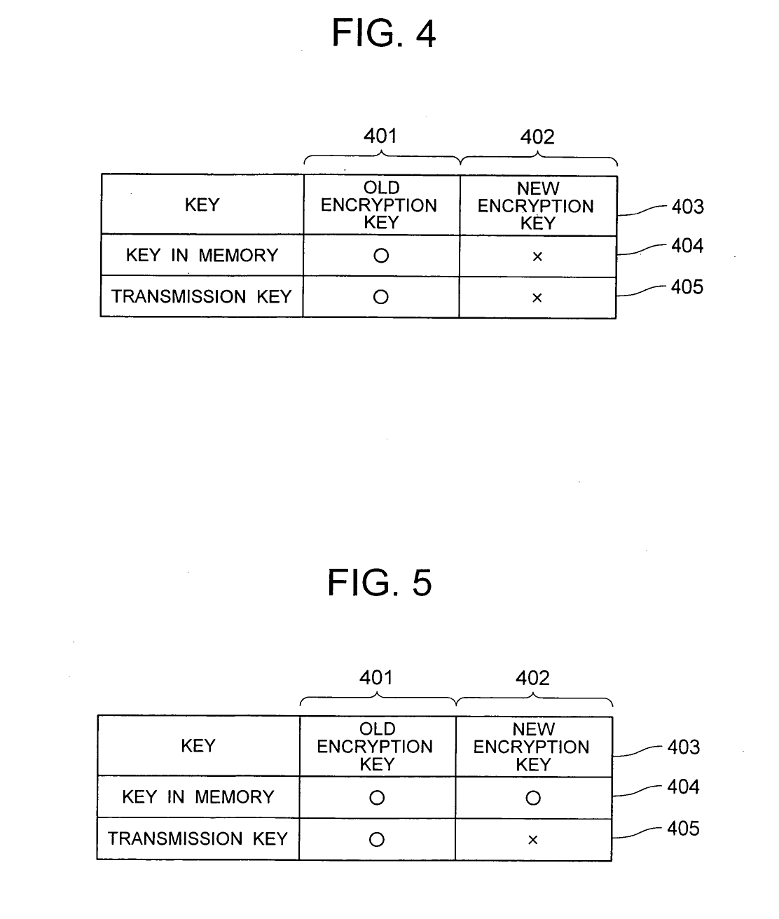

FIGS. 4 to 7 are diagrams showing a key retained in the memory by the network device and a key used at the time of transmission in the initial state, the state “a”, the state “b”, and the final state, respectively. In FIGS. 4 to 7, reference numeral 401 denotes a column describing internal states in which the “key” is the “old encryption key.” Reference numeral 402 denotes a column describing internal states in which the “key” is the “new encryption key.” Reference numeral 403 denotes a row which describes key classifications. Reference numeral 404 denotes a row which describes the retaining state of the encryption key in the memory in the network device. Reference numeral 405 denotes a row which describes the use state of the encryption key used when the network device transmits data. Each of circles shown in FIGS. 4 to 7 indicates that the key is retained in the memory or indicates that the key is used in transmission.

In FIG. 4 which shows the key in the initial state 301 and the key used at the time of transmission, information of the old encryption key is described in the memory and it is described to use the old encryption key at the time of data transmission.

In FIG. 5 which shows the key in the state “a” 302 and the key used at the time of transmission, information of the old encryption key and information of the new encryption key are described in the memory and it is described to use the old encryption key at the time of data transmission.

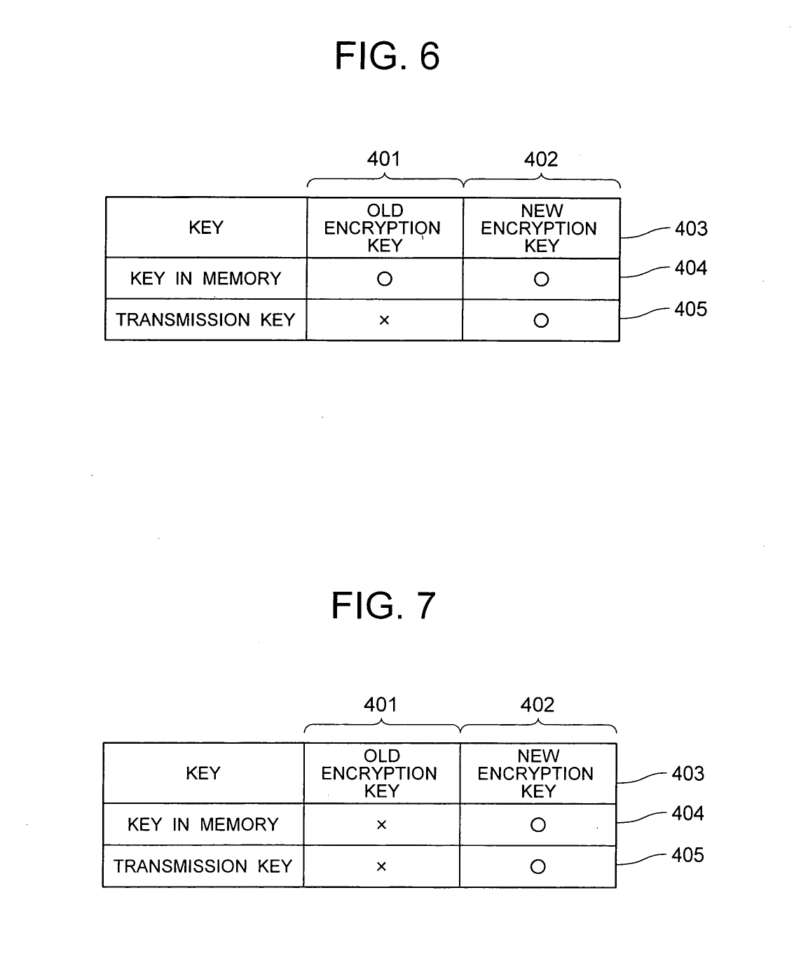

In FIG. 6 which shows the key in the state “b” 303 and the key used at the time of transmission, information of the old encryption key and information of the new encryption key are described in the memory and it is described to use the new encryption key at the time of data transmission.

In FIG. 7 which shows the key in the final state 304 and the key used at the time of transmission, information of the new encryption key is described in the memory and it is described to use the new encryption key at the time of data transmission.

Processing operation conducted by each of a network device which transmits a key update instruction and network devices which receives the key update instruction in the initial state 301, the state “a” 302 and the state “b” 303 will now be described. These kinds of processing is processing conducted by execution of a program. By the way, the network device which transmits a key update instruction is an only one arbitrary network device in the network system, and the network devices which receive the key update instruction are all the other network devices.

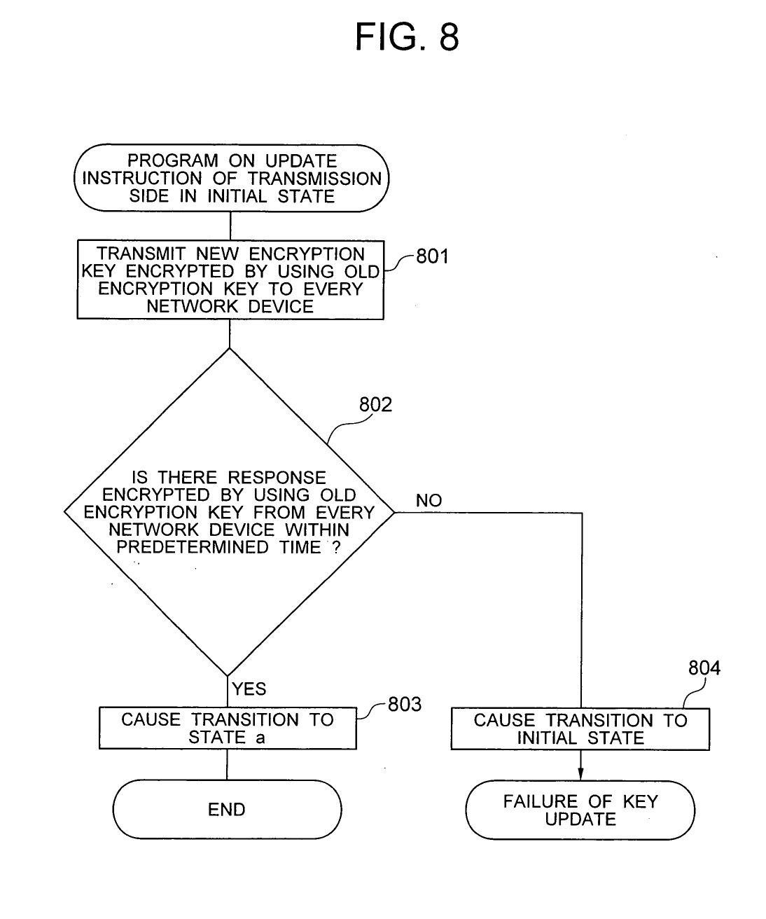

FIG. 8 is a flow chart showing processing operation in a network device which transmits an update instruction for a key in an initial state. First, this will now be described.

(1) The network device, which transmits a key update instruction, first transmits a new encryption key encrypted by using an old encryption key to every network device (step 801).

(2) Subsequently, the network device which transmits the key update instruction makes a decision whether a response (response representing reception of the new encryption key) encrypted by using the old encryption key has been obtained from every network device within a predetermined time (step 802).

(3) If it is found by the decision at the step 802 that the response encrypted by using the old encryption key has been obtained from every network device within the predetermined time, the network device which transmits the key update instruction causes transition of the state of the own device to the state “a” and finishes this processing (step 803).

(4) If it is found by the decision at the step 802 that the response encrypted by using the old encryption key has not been obtained from every network device within the predetermined time, the network device which transmits the key update instruction causes the state of the own device to remain in the initial state, and the key update fails (step 804).

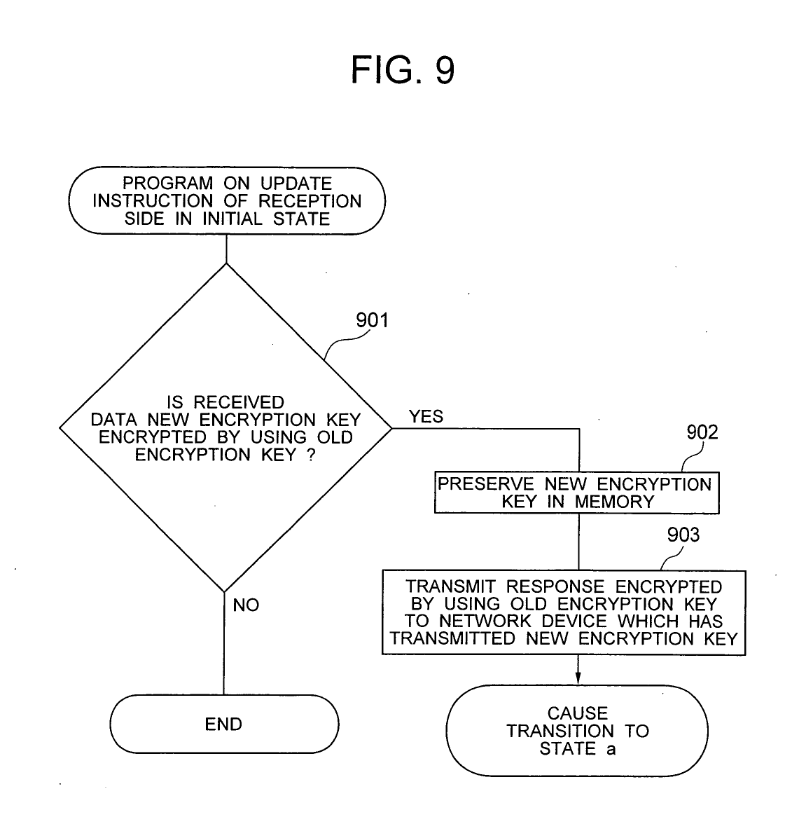

FIG. 9 is a flow chart showing processing operation in a network device which receives an update instruction for a key in the initial state. This will now be described.

(1) Upon receiving data, the network device in the initial state makes a decision whether the received data is data of the new encryption key encrypted by using the old encryption key. If the received data is not data of the new encryption key encrypted by using the old encryption key, the network device finishes this processing without doing anything (step 901).

(2) If it is found by the decision at the step 901 that the received data is data of the new encryption key encrypted by using the old encryption key, the network device preserves the received new encryption key in the memory, transmits a response encrypted by using the old encryption key to the network device which has transmitted data of the new encryption key, causes transition of the state of the own device to the state “a”, and finishes this processing (steps 902 and 903).

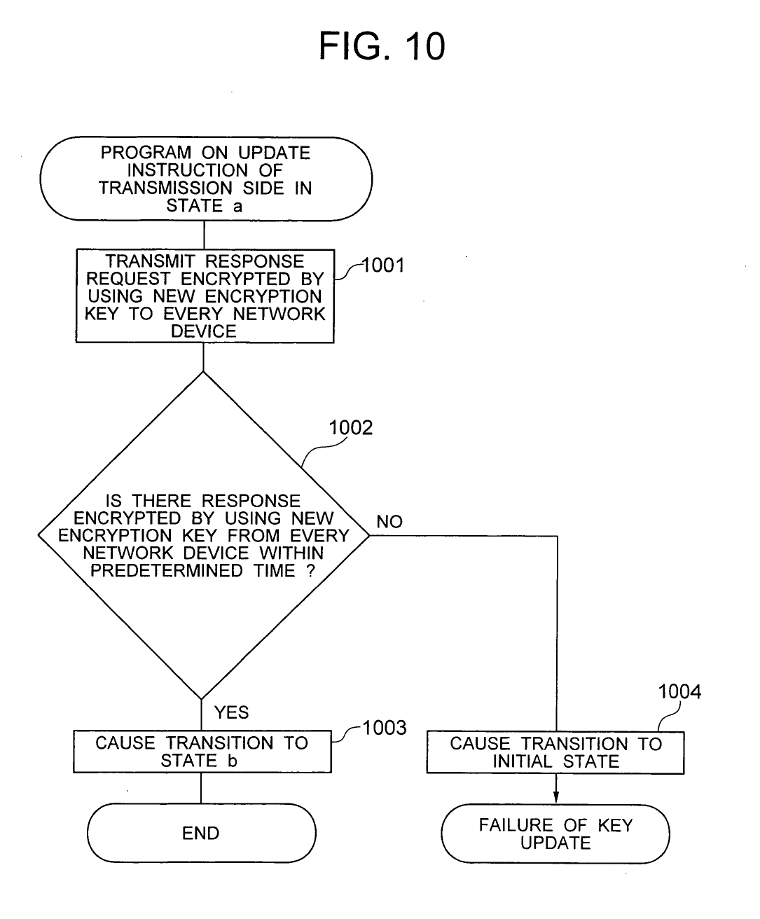

FIG. 10 is a flow chart showing processing operation in a network device which transmits an update instruction for a key in the state “a”. This will now be described. This processing is conducted after a response encrypted by using the old encryption key is obtained from every network device in the processing at the step 802 described with reference to FIG. 8 and the transition to the state “a” is conducted.

(1) The network device which has transmitted a key update instruction in the state “a” transmits a response request encrypted by using the new encryption key to every network device (step 1001).

(2) Subsequently, the network device which has transmitted the key update instruction makes a decision whether a response encrypted by using the new encryption key is obtained from every network device within a predetermined time (step 1002).

(3) If it is found by the decision at the step 1002 that the response encrypted by using the new encryption key has been obtained from every network device within the predetermined time, the network device which has transmitted the key update instruction causes the transition of the own device to the state “b” and finishes this processing (step 1003).

(4) If it is found by the decision at the step 1002 that the response encrypted by using the new encryption key has not been obtained from every network device within the predetermined time, the network device which has transmitted the key update instruction causes the state of the own device to the initial state. In this case, the key update fails (step 1004).

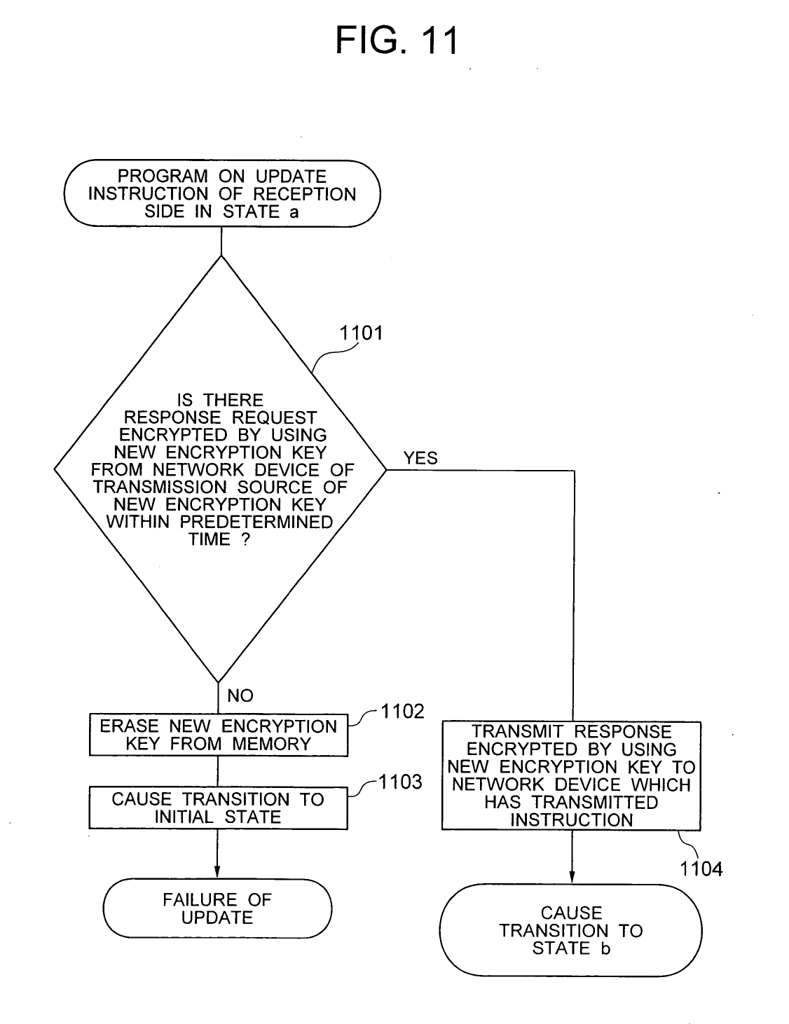

FIG. 11 is a flow chart showing processing operation in a network device which receives a key update instruction in the state “a”. This will now be described.

(1) A network device which has received the key update instruction in the state “a” makes a decision whether a response request encrypted by using the new encryption key is obtained from the network device which is the transmission source of the new encryption key within a predetermined time (step 1101).

(2) If it is found by the decision at the step 1101 that a response request encrypted by using the new encryption key is obtained from the network device which is the transmission source of the new encryption key within the predetermined time, the network device which has received the key update instruction in the state “a” transmits a response encrypted by using the new encryption key to the network device which has transmitted the instruction, causes transition of the state of the own device to the state “b”, and finishes this processing (step 1104).

(3) If it is found by the decision at the step 1101 that a response request encrypted by using the new encryption key is not obtained from the network device which is the transmission source of the new encryption key within the predetermined time, the network device which has received the key update instruction in the state “a” erases the information of the new encryption key preserved in the memory by the processing at the step 902 in FIG. 9, from the memory, and causes transition of the state of the own device to the initial state. In this case, the key update fails (steps 1102 and 1103).

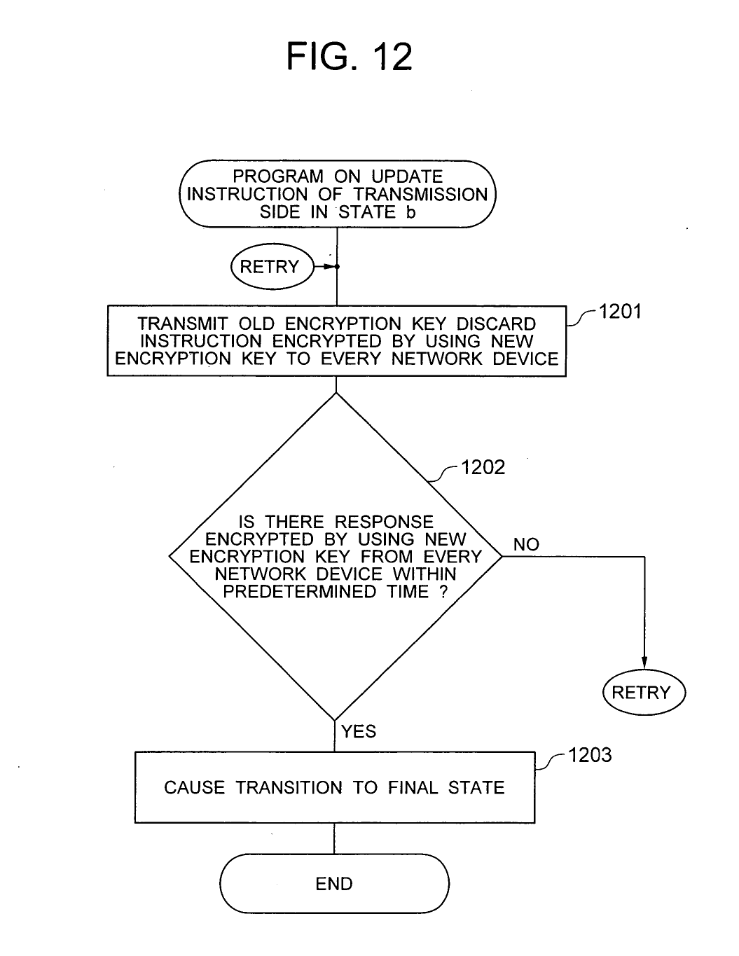

FIG. 12 is a flow chart showing processing operation in a network device which has transmitted an update instruction for a key in the state “b”. This will now be described. This processing is conducted after a response encrypted by using the new encryption key is obtained from every network device in the processing at the step 1002 described with reference to FIG. 10 and the transition to the state “b” is conducted.

(1) The network device which has transmitted a key update instruction in the state “b” transmits a discard instruction of the old encryption key encrypted by using the new encryption key to every network device (step 1201).

(2) Subsequently, the network device which has transmitted the key update instruction makes a decision whether a response encrypted by using the new encryption key is obtained from every network device within a predetermined time (step 1202).

(3) If it is found by the decision at the step 1202 that the response encrypted by using the new encryption key has been obtained from every network device within the predetermined time, the network device which has transmitted the key update instruction causes transition of the state of the own device to the final state and finishes this processing (step 1203).

(4) If it is found by the decision at the step 1202 that the response encrypted by using the new encryption key has not been obtained from every network device within the predetermined time, the network device which has transmitted the key update instruction returns to the processing which begins with the step 1201, and repeats the processing.

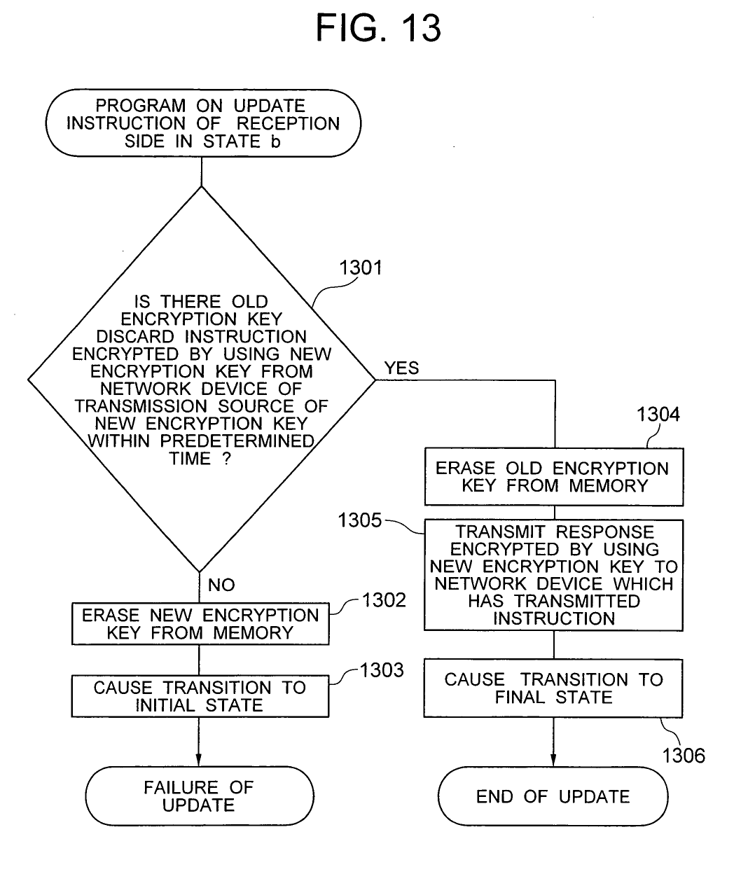

FIG. 13 is a flow chart showing processing operation in a network device which receives a key update instruction in the state “b”. This will now be described.

(1) A network device which has received the key update instruction in the state “b” makes a decision whether a discard instruction of the old encryption key encrypted by using the new encryption key is obtained from the network device which is the transmission source of the new encryption key within a predetermined time (step 1301).

(2) If it is found by the decision at the step 1301 that a discard instruction of the old encryption key encrypted by using the new encryption key is obtained from the network device which is the transmission source of the new encryption key within the predetermined time, the network device which has received the key update instruction in the state “b” erases the old encryption key from the memory (step 1304).

(3) Subsequently, a network device which has received the key update instruction in the state “b” transmits a response encrypted by using the new encryption key to the network device which has transmitted the instruction, causes transition of the state of the own device to the final state, and finishes this processing (steps 1305 and 1306).

(4) If it is found by the decision at the step 1301 that a discard instruction of the old encryption key encrypted by using the new encryption key is not obtained from the network device which is the transmission source of the new encryption key within the predetermined time, the network device which has received the key update instruction in the state “b” erases the information of the new encryption key preserved in the memory by the processing at the step 902 in FIG. 9, and causes transition of the state of the own device to the initial state. In this case, the key update fails (steps 1302 and 1303).

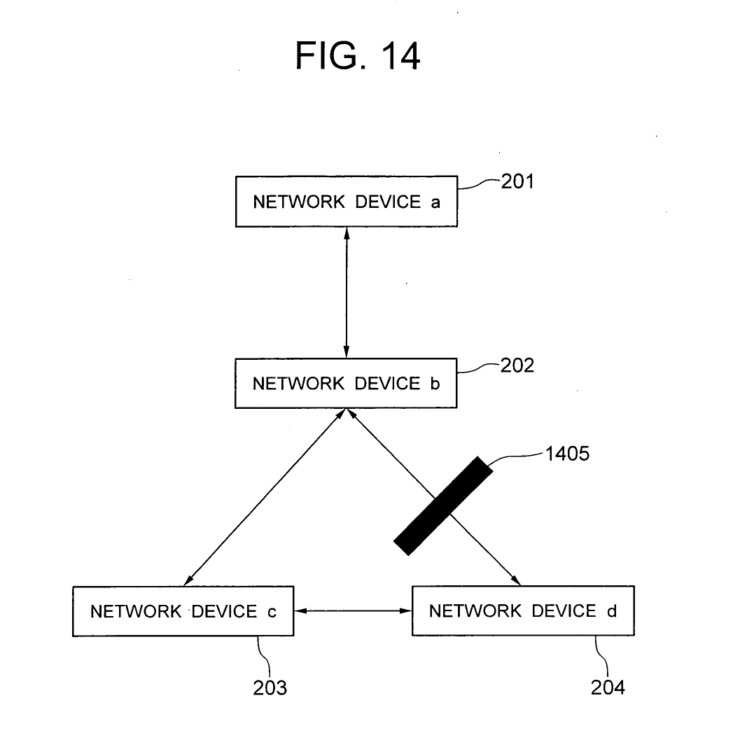

FIG. 14 is a diagram showing an example of a network which is a part of a network system shown in FIG. 2 in the case where a communication route between network devices having a relay function varies. In FIG. 14, reference numeral 1405 denotes an obstacle, and other reference characters shown in FIG. 14 which are the same as those shown in FIG. 2 denote like devices.

The network example shown in FIG. 14 shows an example obtained by extracting a part of a network constituted by the network device “a” 201 to the network device “d” 204 included in the network system shown in FIG. 2. In this example, the obstacle 1405 is present between the network device “b” 202 and the network device “d” 204, and communication between the network device “b” 202 and the network device “d” 204 is intercepted.

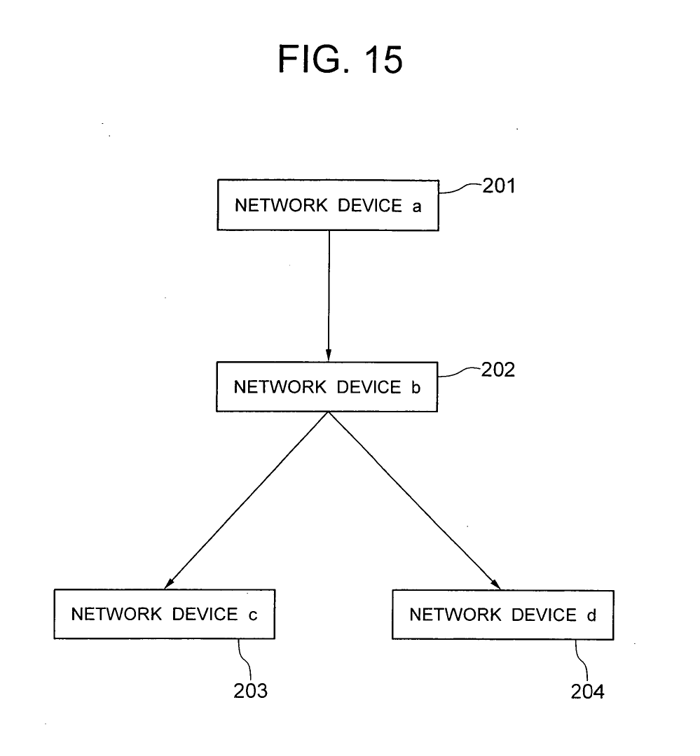

FIG. 15 is a diagram showing communication routes at the time when an obstacle is not present in the example of the network shown in FIG. 14.

If the obstacle 1405 is not present in the network example shown in FIG. 14, then communication routes are formed as shown in FIG. 15 so as to connect the network device “a” 201 to the network device “b” 202, connect the network device “b” 202 to the network device “c” 203 and the network device “d” 204, connect the network device “c” 203 to the network device “b” 202, and connect the network device “d” 204 to the network device “b” 202.

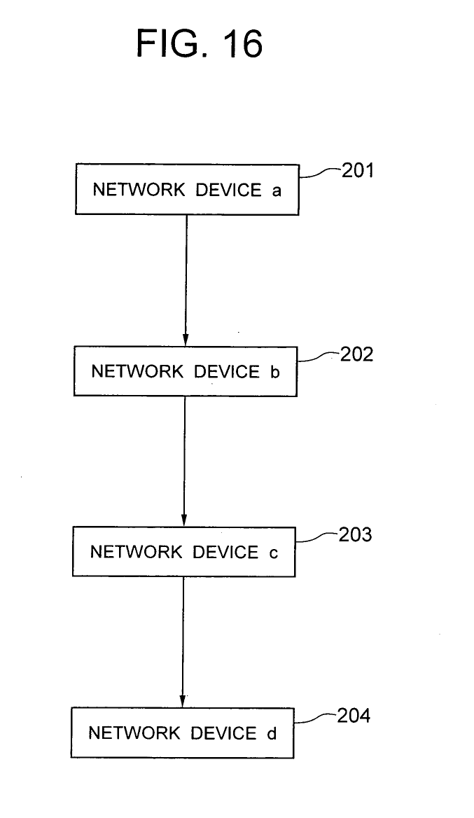

FIG. 16 is a diagram showing a communication route at the time when the obstacle 1405 is present as in the example of the network shown in FIG. 14.

If the obstacle 1405 is present in the network example shown in FIG. 14, then a communication route is formed as shown in FIG. 16 so as to connect the network device “a” 201 to the network device “b” 202, connect the network device “b” 202 to the network device “c” 203 and the network device “a” 201, connect the network device “c” 203 to the network device “b” 202 and the network device “d” 204, and connect the network device “d” 204 to the network device “c” 203.

Supposing that the network device “a” 201 is the network device which transmits a key update instruction in the network example shown in FIG. 14, communication routes at the time when the above-described key update processing is conducted in the case where the obstacle 1405 is present and in the case where the obstacle 1405 is not present will now be described.

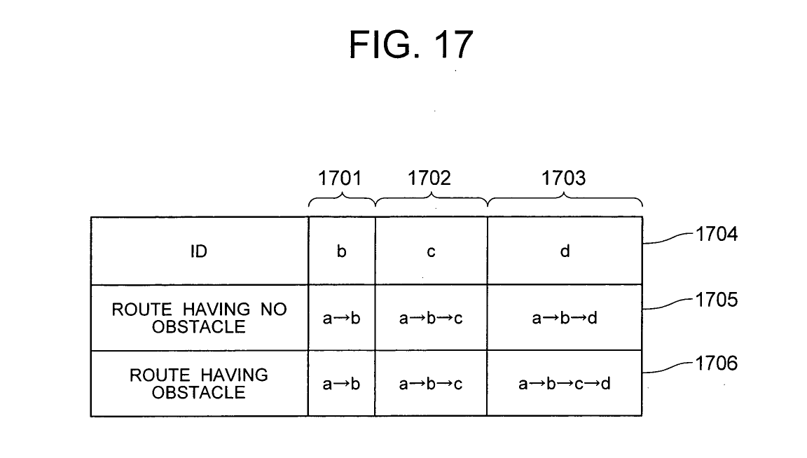

FIG. 17 is a diagram showing communication routes from a network device which transmits a key update instruction to each network device which receives the key update instruction in each of the case where an obstacle is present in a route and the case where an obstacle is not present. In FIG. 17, reference numeral 1701 denotes a column which describes a route to the network device “b”. Reference numeral 1702 denotes a column which describes a route to the network device “c”. Reference numeral 1703 denotes a column which describes a route to the network device “d”. Reference numeral 1704 denotes a row describing “ID” serving as an identifier of a network device which receives a key update instruction. Reference numeral 1705 denotes a row describing communication routes beginning with the network device “a” in the case where the obstacle 1405 is not present. Reference numeral 1706 denotes a row describing communication routes beginning with the network device “a” in the case where the obstacle 1405 is present.

With reference to “route having no obstacle” in the row 1705 shown in FIG. 17, the route to a network device “b” is a→b. The route to a network device “c” is a→b→c. The route to a network device “d” is a→b→d. With reference to route having obstacle” in the row 1706, the route to a network device “b” is a→b. The route to a network device “c” is a→b→c. The route to a network device “d” is a→b→c→d.

In the case where the obstacle 1405 is not present and the communication route is known beforehand, it is possible to conduct the key update in every network device by conducting the key update in the order of the network device “c” 203, the network device “d” 204, and the network device “b” 202. (The order of the network device “c” 203 and the network device “d” 204 does not matter.) Also in the case where the obstacle 1405 is present, it is possible to conduct the key update in every network device by conducting the key update in the order of the network device “d” 204, the network device “c” 203, and the network device “b” 202.

If the communication route cannot be known beforehand, it is impossible to determine in which order key update of the network devices should be conducted. In the key update method according to the embodiment of the present invention, however, there is a state in which both data encrypted by using the old encryption key and data encrypted by using the new encryption key can be transmitted and received, as a transition state of key update. Therefore, it is possible to conduct key update in every network device without knowing the communication route beforehand.

In the key update method according to the embodiment of the present invention, it is also possible to conduct the key update in the same way even if the communication route has been varied by the obstacle 1405 during the key update. Furthermore, the key update may be conducted by the user's operation or may be conducted by the network devices autonomously according to a timer or the like.

Update processing of the encryption key used by the network devices in the network system including a plurality of network devices has been described heretofore. However, the present invention is not restricted to the embodiment described above, but its change and improvement can be made. For example, the above-described embodiment uses the common key cryptsystem in which the encryption key is the same as the decryption key. However, the present invention can be applied to other cryptsystems as well. For example, in the public key cryptsystem, the encryption delivery device may deliver a public key (encryption key) associated with a private key (decryption key) owned by it. Furthermore, it is also possible to use a similar technique even in the case where the communication route has changed depending on not only whether an obstacle is present but also a change in radio wave situation or a movement of a network device.

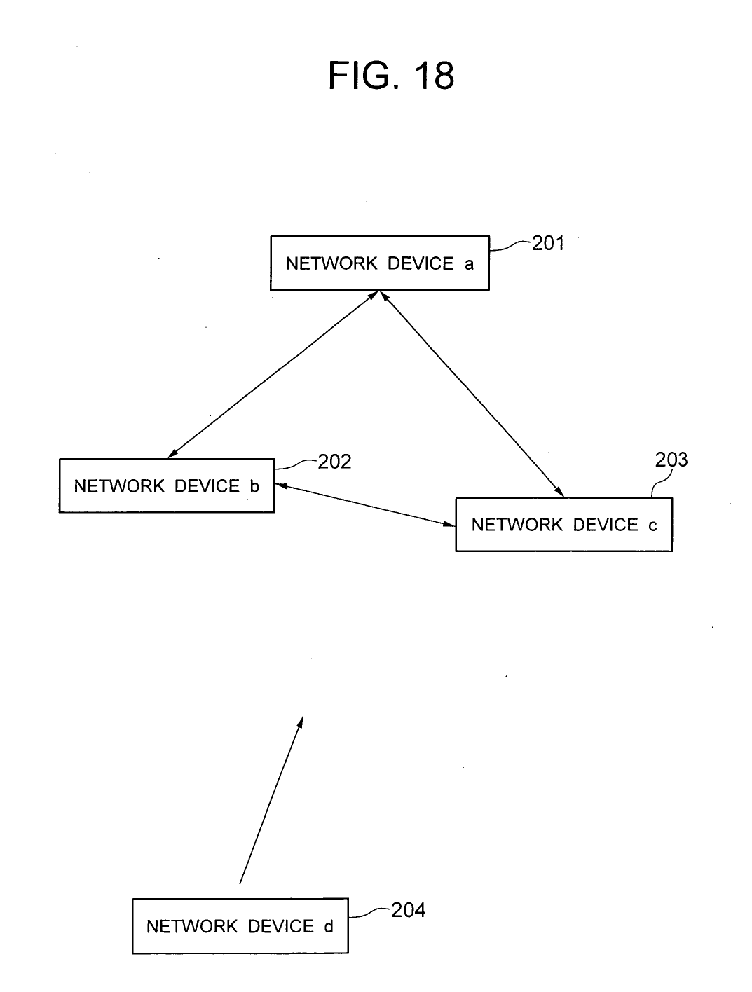

FIG. 18 is a diagram showing processing when a new network device is added to a network system including a plurality of network devices which are conducting encrypted communication. This will now be described. Reference characters shown in FIG. 18 which are the same as those shown in FIG. 2 denote like devices.

It is now supposed that three network devices, as shown in FIG. 18, i.e., the network device “a” 201 to the network device “c” 203 are connected to each other to constitute a network system and encrypted communication can be conducted between network devices. Furthermore, it is now supposed that all of the network device “a” 201, the network device “b” 202 and the network device “c” 203 are using the same key. In other words, it is now supposed that the state of each of the network device “a” 201 to the network device “c” 203 is in neither the state “a” 302 nor the state “b” 303. And it is supposed that the network device “d” 204 is newly added to the network thus constituted.

The network device “d” 204 is authenticated by using different means. The same encryption key as that used by the existing network device “a” 201 to network device “c” 203 is set in the network device “d” 204 by the user. By installing the network device “d” 204 thus set in a necessary place, it becomes possible for the network device “d” 204 to conduct communication with another network device. At this time, it is not necessary to know beforehand which network device the network device “d” 204 conducts communication with.

Key update in the network after the network device “d” 204 is added can be conducted in the same way by using the method described above.

According to the embodiment of the present invention, it thus becomes possible to easily add a new network device to a network system including a plurality of network devices which are conducting encrypted communication, and the network expansion can be easily conducted.

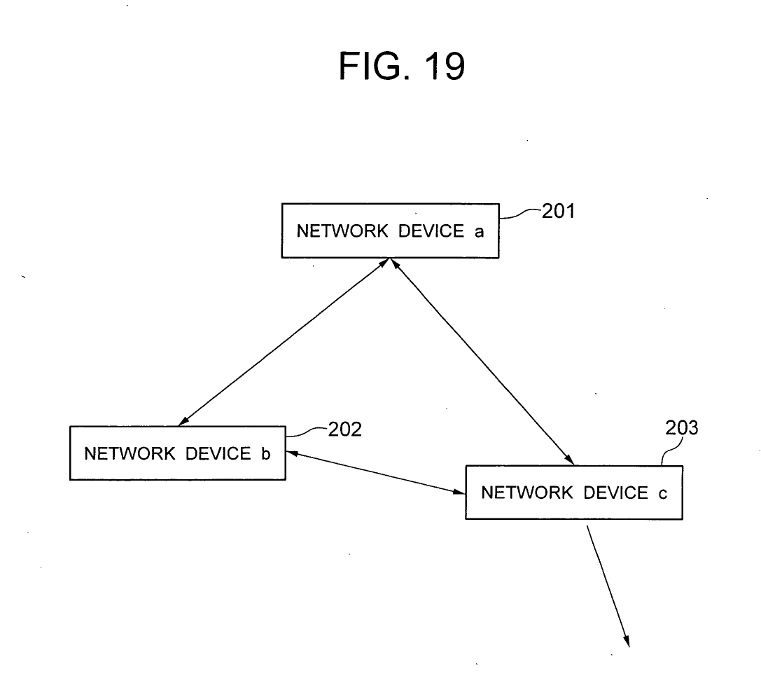

FIG. 19 is a diagram showing processing when removing one network device from a network system including a plurality of network devices which are conducting encrypted communication. This will now be described. Reference characters shown in FIG. 19 which are the same as those shown in FIG. 2 denote like devices.

It is now supposed that three network devices, i.e., the network device “a” 201 to the network device “c” 203 are connected to each other to constitute a network system and encrypted communication can be conducted between network devices. Furthermore, it is now supposed that all of the network device “a” 201, the network device “b” 202 and the network device “c” 203 are using the same key. In other words, it is now supposed that the state of each of the network device “a” 201 to the network device “c” 203 is in neither the state “a” 302 nor the state “b” 303. And it is supposed that the network device “c” 203 is removed from the network thus constituted.

If the network device “c” 203 is removed from the network system in the above-described state, other network devices in the network, i.e., the network device “a” 201 and the network device “b” 202 in this case detect that the network device “c” 203 has been removed. At that time, a new encryption key is set in the network device “a” 201 and the network device “b” 202. As a result, it becomes possible to prevent a network device which is not present in the network from wiretapping the communication.

As for means which detects that the network device “c” 203 has been removed from the network in the foregoing description, periodic polling from a network device connected to the network device “c” 203 or a periodic life signal or the like transmitted from the network device “c” 203 may be utilized.

Key update in the network after the network device “c” 203 is removed from the network can be conducted in the same way by using the method described above.

According to the embodiment of the present invention, encryption key update can be thus conducted even in the case where a certain network device is removed from a network system including a plurality of network devices which are conducting encrypted communication. As a result, the ciphering property of communication can be ensured, and it becomes possible to easily change the network configuration.

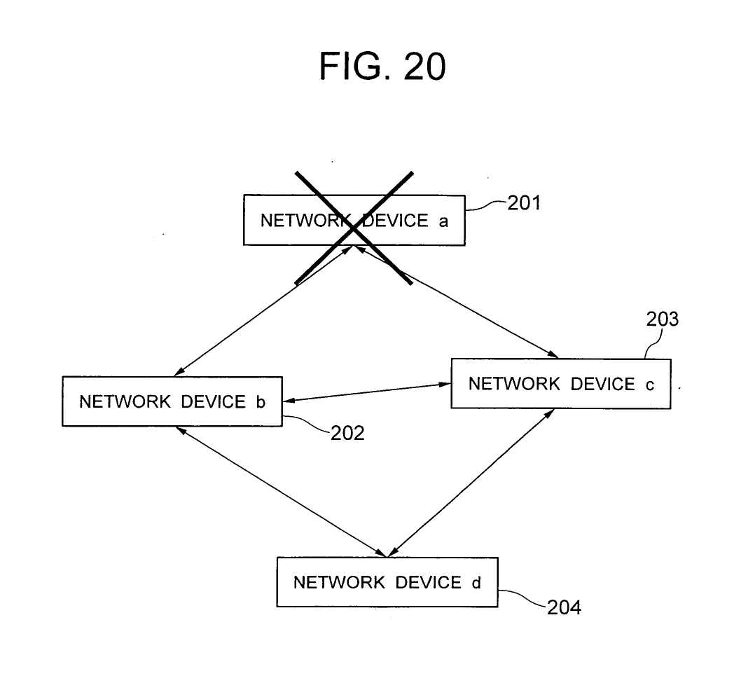

FIG. 20 is a diagram showing processing when a network device which transmits an encryption key update instruction malfunctions in a network system including a plurality of network devices which are conducting encrypted communication. This will now be described. Reference characters shown in FIG. 20 which are the same as those shown in FIG. 2 denote like devices.

It is now supposed that four network devices, i.e., the network device “a” 201 to the network device “d” 204 are connected to each other to constitute a network system and encrypted communication can be conducted between network devices. Furthermore, it is now supposed that the network device “a” 201 is a network device which transmits a key update instruction and the network device “b” 202, the network device “c” 203 and the network device “d” 204 are network devices which receives the key update instruction.

It is now supposed that the network device “a” 201, which transmits a key update instruction periodically or in response to an instruction received from a user in the network system shown in FIG. 20, malfunctions. In this case, another network device detects the malfunction of the network device “a” 201, and takes over the function of transmitting the key update instruction. As for means which detects the malfunction of the network device “a” 201 in this case, polling from the network device “b” 202 or the network device “c” 203 connected to the network device “a” 201 or a periodic life signal or the like transmitted from the network device “a” 201 may be utilized.

According to the embodiment of the present invention, it becomes possible to construct a network which is robust against a failure or the like in the network device which transmits a key update instruction, as described above.

Each processing in the embodiment of the present invention described above can be formed by a program and executed by a CPU included in a computer. Those programs can be stored in a recording medium such as a FD (Floppy Disk), a CDROM (Compact Disk Read Only Memory) or a DVD (Digital Video Disk) and provided, and provided as digital information via the network.

Heretofore, the embodiment of the present invention has been described. However, the present invention is not restricted to the embodiment described above, but its change and improvement can be made. Hereafter, a modification thereof will be described.

(1) In the embodiment of the present invention described above, each network device may be another portable electronic device such as a headset or a portable game machine. Furthermore, each network device may be a small-sized stationary electronic device.

(2) Furthermore, an input device such as a sensor like a human detection sensor, a temperature sensor, a humidity sensor or an illuminance sensor, or a camera may be directly incorporated in each network device. Furthermore, an input device such as a LED (Light Emitting Diode), buzzer or a liquid crystal display may be incorporated directly in each network device.

(3) In the embodiment of the present invention described above, each network device is separated physically from a device connected thereto. In the present invention, they can be formed as one body. In this case, a program which controls the device may be mounted on the network device.

(4) In the present invention, every device included in the network needs not be a device according to the present invention having a relay function, but a device having no relay function to which the present invention is not applied may be included.

It should be further understood by those skilled in the art that although the foregoing description has been made on embodiments of the invention, the invention is not limited thereto and various changes and modifications may be made without departing from the spirit of the invention and the scope of the appended claims.

1. A network device equipped with a relay function and provided in a network, the network device comprising:
a management unit which retains and manages an encryption key used for communication in the network;
a first transmission unit which transmits a new encryption key used after update encrypted by using an old encryption key used before the update to other network devices and orders encryption key update, at time of encryption key update;
a first reception unit which receives a reception response for the new encryption key encrypted by using the old encryption key from the other network devices;
a second transmission unit which transmits a response request encrypted by using the new encryption key to the other network devices when the reception response for the new encryption key is received; and
a second reception unit which receives a response encrypted using the new encryption key from the other network devices.

2. A network device equipped with a relay function and provided in a network, the network device comprising:
a management unit which retains and manages an encryption key used for communication in the network;
a first transmission unit which periodically generates a new encryption key, and transmits the new encryption key used after update encrypted by using an old encryption key used before the update to other network devices and orders encryption key update, at time of encryption key update;
a first reception unit which receives a reception response for the new encryption key encrypted by using the old encryption key from the other network devices;
a second transmission unit which transmits a response request encrypted by using the new encryption key to the other network devices when the reception response for the new encryption key is received; and
a second reception unit which receives a response encrypted by using the new encryption key from the other network devices.

3. A network device equipped with a relay function and provided in a network, the network device comprising:
a management unit which retains and manages an encryption key used for communication in the network;
a first transmission unit which transmits a new encryption key used after update encrypted by using an old encryption key used before the update to other network devices and orders encryption key update, at time of encryption key update;
a first reception unit which receives a reception response for the new encryption key encrypted by using the old encryption key from the other network devices;
a second transmission unit which transmits a response request encrypted by using the new encryption key to the other network devices when the reception response for the new-encryption key is received;
a second reception unit which receives a response encrypted by using the new encryption key from the other network devices; and
a third transmission unit which transmits a discard instruction of the old encryption key encrypted by using the new encryption key to the other network devices, when the response encrypted by using the new encryption key is received from the other network devices.

4. A network device equipped with a relay function and provided in a network, the network device comprising:
a management unit which retains and manages an encryption key used for communication in the network;
a first transmission unit which transmits a new encryption key used after update encrypted by using an old encryption key used before the update to other network devices and orders encryption key update, at time of encryption key update;
a first reception unit which receives a reception response for the new encryption key encrypted by using the old encryption key from the other network devices;
a second transmission unit which transmits a response request encrypted by using the new encryption key to the other network devices when the reception response for the new encryption key is received;
a second reception unit which receives a response encrypted by using the new encryption key from the other network devices;
a third transmission unit which transmits a discard instruction of the old encryption key encrypted by using the new encryption key to the other network devices, when the response encrypted by using the new encryption key is received from the other network devices; and
an erasing unit which erases the old encryption key in the own network device, when confirmation of the old encryption key discard encrypted by using the new encryption key is received from the other network devices.

5. A network device equipped with a relay function and provided in a network, the network device comprising:
a management unit which retains and manages an encryption key used for communication in the network;
a first reception unit which receives a new encryption key used after update encrypted by using an old encryption key used before the update from a network device which orders encryption key update;
a first transmission unit which transmits a reception response encrypted by using the old encryption key to the network device which has ordered the encryption key update, when the new encryption key is received;
a second reception unit which receives a response request encrypted by using the new encryption key from the network device which has ordered the encryption key update; and
a second transmission unit which transmits a response encrypted by using the new encryption key to the network device which has ordered the encryption key update, in response to the received response request.

6. A network device equipped with a relay function and provided in a network, the network device comprising:
a management unit which retains and manages an encryption key used for communication in the network;
a first transmission unit which transmits a new encryption key used after update encrypted by using an old encryption key used before the update to other network devices and orders encryption key update, when given a key update instruction encrypted by using an old encryption key;
a first reception unit which receives a reception response for the new encryption key encrypted by using the old encryption key from the other network devices;
a second transmission unit which transmits a response request encrypted by using the new encryption key to the other network devices when the reception response for the new encryption key is received; and
a second reception unit which receives a response encrypted by using the new encryption key from the other network devices.

7. A network device equipped with a relay function and provided in a network, the network device comprising:
a management unit which retains and manages an encryption key used for communication in the network;
a first reception unit which receives a new encryption key used after update encrypted by using an old encryption key used before the update from a network device which orders encryption key update;
a first transmission unit which transmits a reception response encrypted by using the old encryption key to the network device which has ordered the encryption key update, when the new encryption key is received;
a second reception unit which receives a response request encrypted by using the new encryption key from the network device which has ordered the encryption key update;
a second transmission unit which transmits a response encrypted by using the new encryption key to the network device which has ordered the encryption key update, in response to the received response request; and
a third transmission unit which erases the old encryption key in the own network device and transmits a discard confirmation encrypted by using the new encryption key to the network device which has ordered the encryption key update, when a discard instruction of the old encryption key encrypted by using the new encryption key is received from the network device which has ordered the encryption key update.

8. The network system which connects a plurality of network devices according to claim 1.

9. The network system according to claim 8, wherein connection between the network devices is conducted in a radio form.

10. An update method of an encryption key used for communication by a network device equipped with a relay function and provided in a network, the update method comprising the steps of:
delivering a new encryption key used after update encrypted by using an old encryption key used before the update to other network devices;
delivering a response request encrypted by using the new encryption used key used after confirming reception of the old encryption key in the other network devices; and
confirming a response from the other network devices encrypted by using the new encryption key.

11. An update method of an encryption key used for communication by a network device equipped with a relay function and provided in a network, the update method comprising the steps of:
periodically generating a new encryption key used after update;
delivering the new encryption key used after update encrypted by using an old encryption key used before the update to the other network devices;
delivering a response request encrypted by using the new encryption key after confirming reception of the old encryption key in the other network devices; and
confirming a response from the other network devices encrypted by using the new encryption key.

12. An update method of an encryption key used for communication by a network device equipped with a relay function and provided in a network, the update method comprising the steps of:
delivering a new encryption key used after update encrypted by using an old encryption key used before the update to other network devices;
delivering a response request encrypted by using the new encryption key, after confirming reception of the old encryption key in other network devices;
confirming a response from the other network devices encrypted by using the new encryption key; and
delivering a discard instruction of the old encryption key encrypted by using the new encryption key, after confirming the response encrypted by using the new encryption key.

13. An update method of an encryption key used for communication by a network device equipped with a relay function and provided in a network, the update method comprising the steps of:
receiving a new encryption key used after update encrypted by using an old encryption key used before the update from a network device which conducts encryption key update;
transmitting a reception response encrypted by using the old encryption key to a network device which has ordered the encryption key update, when the new encryption key is received;
receiving a response request encrypted by using the new encryption key from the network device which has ordered the encryption key update; and
transmitting a response encrypted by using the new encryption key to the network device which has ordered the encryption key update in response to the received response request.

14. An update method of an encryption key used for communication by a network device equipped with a relay function and provided in a network, the update method comprising the steps of:
delivering a new encryption key used after update encrypted by using an old encryption key used before the update to other network devices, by receiving a key update instruction encrypted by using the old encryption key before the update;
delivering a response request encrypted by using the new encryption key after confirming reception of the old encryption key in other network devices; and
confirming a response from the other network devices encrypted by using the new encryption key.
